(19) United States
(12) Patent Application Publication
(10) Pub. No.: US 2005/0194088 A1
(43) Pub. Date: Sep. 8, 2005

(54) Method and apparatus for making corrugated cardboard

(76) Inventor: Herbert B. Kohler, Uniontown, OH (US)

Correspondence Address: PEARNE & GORDON LLP, 1801 EAST 9TH STREET, SUITE 1200, CLEVELAND, OH, 44114-3108, US

(21) Appl. No.: 10/903,189

(22) Filed: Jul. 30, 2004

Related U.S. Application Data
(60) Provisional application No. 60/549,381, filed on Mar. 2, 2004.

(51) Int. Cl. B31F 1/20

(52) U.S. Cl. 156/210; 156/470

(57) ABSTRACT

A method and apparatus for producing a corrugated product are provided. In one embodiment, the apparatus includes a turnbar system the cooperates with a glue machine for applying glue to the exposed flute crests of a single-faced corrugated web traveling therethrough. The turnbar system and glue machine define a web path of the single-faced web having a web path geometry such that after exiting the glue machine, the single-faced web enters a double-facer oriented having the exposed flute crests facing away from the stationary hotplates in the double-facer.

This application claims the benefit of U.S. Provisional Patent Application Ser. No. 60/549,381 filed Mar. 2, 2004.

### BACKGROUND OF THE INVENTION

1. Field of the Invention

The invention relates to a corrugator line. More particularly, it relates to such a line that is effective to improve the printed or printable quality of corrugated cardboard, and to permit lower solids glue to be applied to the exposed flute crests of a single-faced corrugated web at the glue machine prior to entering a double-facer where a second-face sheet is applied.

2. Description of Related Art

Corrugated cardboard composite is used in a large number of applications. It is particularly desirable in packaging applications because it is rugged and has high dimensional and structural integrity making it ideal for shipping goods via standard carriers, while at the same time it provides a generally smooth outer surface that is suitable for printing indicia.

A corrugated cardboard composite generally consists of first- and second-face sheets of cardboard material having a relatively flat or smooth contour, and a corrugated cardboard sheet sandwiched in between the first- and second-face sheets. The corrugated sheet generally is made by passing a flat cardboard sheet between toothed rollers in a conventional manner, with the teeth of one roller being received within complementary valleys between adjacent teeth of the other roller. The toothed rollers resemble complementary engaged sprockets except for their length. By passing the cardboard sheet between these rollers, the sheet is pressed into a pattern conforming to the pathway between the toothed rollers, negotiating the opposing teeth and valleys of the rollers such that the resulting sheet has a fluted surface contour comprising periodic peaks (flutes) and valleys extending transversely of the sheet's length. The resulting corrugated board has a transverse cross-section resembling a sine wave, where a peak or flute on one side of the board corresponds to a valley on the opposite side of the board. In addition to the above described method, other well known methods exist for producing the corrugated sheet having periodic flutes extending transversely of the sheet's length, and corrugated sheet produced by any method is suitable for use in the present invention described below.

To produce the corrugated cardboard composite, the corrugated sheet is sandwiched between the opposing first- and second-face sheets by gluing the flute crests on one side of the corrugated sheet to the adjacent face sheet. This process generally is carried out by first producing a single-faced composite web wherein the corrugated sheet is glued to the first-face sheet leaving the flute crests opposite the first-face sheet exposed, then subsequently gluing the exposed flute crests to the second-face sheet to provide the finished corrugated cardboard composite having an overall first-face: corrugated sheet: second-face construction.

To carry out this method, a conventional corrugator production line includes a single-facer to produce the single-faced composite web from the respective first-face and corrugated sheets, a glue machine to apply glue to the crests of the exposed flutes opposite the first-face sheet, and a double-facer to apply the second-face sheet to the glue-tipped flutes of the single-faced composite, thereby producing a finished double-faced corrugated cardboard composite web. Such a conventional production line is shown in FIG. 1 labeled as “Conventional.”

The second-face sheet conventionally is the face of the cardboard composite that is printed with graphics or other indicia, and therefore it is desirable to maintain a smooth, high quality printable or printed outer surface for the second-face sheet, even after it is adhered to the exposed flute crests to provide the finished corrugated composite. A substantial drawback to the conventional corrugator production line as illustrated in FIG. 1 and more fully described below is that in the conventional production line, the outer surface of the second-face sheet (the printed/printable surface) is dragged across stationary hotplates in the double-facer. The hotplates are used to drive off water from the glue and to bring starch in the glue to the gel point so the second-face sheet sticks to the corrugated sheet. Dragging the outer surface of the second-face sheet across these stationary hotplates results in scuffing the surface which can damage the print quality of preprinted indicia as well as the printable quality of the surface for post-printing.

Another drawback to conventional corrugating operations is that conventional glue machines apply far more glue to the exposed flute crests of the single-faced web than is necessary to achieve a bond with the second-face web. This is done purposely in order to provide sufficient moisture to the second-face web (to be adhered to the glue-applied flute crests) to balance out the moisture already present in the first-face side of the composite. Conventionally, this has been deemed necessary to avoid warp because a substantial amount of moisture is contributed to the first-face side of the composite in the single-facer due to the amount of glue applied to adhere the first-face sheet to the corrugated sheet.

The excess glue (water) conventionally applied in the glue machine to combat warpage in the composite is wasteful and expensive. The inventor herein has invented a glue machine capable of applying a precisely metered amount of high solids-content, low-moisture glue to the exposed flute crests of the single-faced composite. This improved glue machine is fully described in U.S. Pat. No. 6,602,546, incorporated herein by reference. However, a concern about using such precisely metered thin films of high-solids (low-water) content glue is that if one reduces the glue application at the glue machine low enough, at some point the higher moisture level in the single-face may cause warp in the double-faced composite that is uncorrectable. This is particularly problematic considering that as basis glue weights continue to come down, a glue machine capable of continually reducing glue weight application in order to have the smoothness required for printing becomes more important. However, based on the conventional setup, less glue (water) applied at the glue machine may result in a moisture imbalance and contribute to substantial warping.

This problem potentially could be overcome by retrofitting the single-facers in conventional corrugator lines with glue metering systems such as those described in U.S. Pat. Nos. 6,068,701 and 6,602,546 (both incorporated herein by reference) to reduce the amount of moisture applied in the single-facer. The result would be improved quality but the amount of starch reduction in the glue would make the payback relatively long. The result is there is a need to widen the moisture control window to make the corrugator less sensitive to heat and speed changes, and the resulting composite less susceptible to warp as the amount of starch (glue) used continues to be reduced, without having to retrofit the single-facers and other equipment in the conventional installations. Simply adding more water in the glue machine to increase the moisture content at the second-face side is not the solution, and will do nothing more than make the double-faced cardboard composite more dimensionally unstable.

Another problem of prime importance is that the double-faced liner is supposed to be the quality printed side but is dragged through the hotplates where it can be scuffed during manufacture.

There is a need in the art for an improved corrugated cardboard production line for making double-faced corrugated cardboard composite which accommodates high-solids, low-moisture content glue being applied at the glue machine but which does not result in any appreciable warpage. There is also a need for an improved corrugated cardboard production line whereby the printed/printable second-face outer surface is not dragged over the stationary hotplates in the double-facer. In particular, a production line that both accommodates low-moisture content glue without warpage, and eliminates dragging the printed/printable surface of the composite across the stationary hotplates would be highly desirable.

### BRIEF DESCRIPTION OF THE DRAWINGS

FIG. 1 shows, schematically, a side view of a conventional corrugator line for making double-faced corrugated composite board.

FIG. 2 shows, schematically, a side view of a corrugator line for making double-faced corrugated composite board including a turnbar system according to a preferred embodiment of the invention.

FIG. 3 shows a first perspective view of a portion of the corrugator line in FIG. 2 showing the single-faced web 50 threaded through the turnbar system, wherein the double-facer is indicated schematically at 20.

FIG. 4 shows a second perspective view of the portion shown in FIG. 2.

FIG. 5 shows a close-up perspective view of the glue machine of FIG. 2, having the single-faced web 50 and second-face web 60 threaded therethrough according to the present invention.

FIG. 6 shows a perspective view similar to FIG. 4, except the glue machine and turnbar system are threaded for making triple-faced corrugated cardboard composite, instead of double-faced as in FIG. 4.

### SUMMARY OF THE INVENTION

An apparatus for producing a corrugated product is provided. The apparatus includes a glue machine, a double-facer and a turnbar system. The glue machine is adapted to apply glue to exposed flute crests of a single-faced corrugated web traveling through the glue machine. The turnbar system cooperates with the glue machine to define a web path for the traveling single-faced web. The web path has a web path geometry such that the single-faced web following the web path will enter the double-facer, after exiting the glue machine, having its exposed flute crests facing a direction opposite from the direction faced by the exposed flute crests on entry of the single-faced web in the web path.

A further apparatus according to the invention is provided, which includes a glue machine for applying glue to exposed flute crests of a single-faced corrugated web traveling therethrough, and a double-facer adapted to receive the single-faced web after exiting the glue machine. The double-facer also is adapted to direct a second-face sheet web into contact with the exposed flute crests and to bond the single-faced web to the second-face sheet to form a double-faced corrugated composite web. The apparatus defines a web path therethrough for the traveling single-faced web. The glue machine is located upstream of the double-facer along the web path. The web path has a web path geometry such that the single-faced web following the web path will enter the double-facer having its exposed flute crests facing a direction opposite from the direction faced by the exposed flute crests on entering the glue machine along the web path.

A method of producing a corrugated product also is provided, including the steps of delivering a single-faced corrugated web, having glue applied to exposed flute crests thereof, to a double facer including at least one stationary hotplate defining a planar surface, and conveying the single-faced web through the double-facer along a substantially planar path that is parallel to and located adjacent the planar surface defined by the at least one hotplate. On entering the double-facer, the single-faced web is oriented such that its exposed flute crests are facing away from the planar surface defined by the at least one stationary hotplate.

A further apparatus for producing a corrugated product also is provided. The apparatus includes a glue machine for applying glue to exposed flute crests of a single-faced corrugated web traveling therethrough, a double-facer adapted to receive the single-faced web after the single-faced web exits the glue machine and effective to cause a second-face sheet to come into contact with the exposed flute crests and to bond the single-faced web to the second-face sheet to form a double-faced corrugated composite web, and means for directing a web path for the single-faced corrugated web through the apparatus to provide a web path geometry such that the single-faced corrugated, web following the web path, will enter the double-facer having its exposed flute crests facing a direction opposite from the direction faced by the exposed flute crests on entering the apparatus.

### DETAILED DESCRIPTION OF PREFERRED EMBODIMENTS OF THE INVENTION

In a preferred embodiment, the invention includes a glue machine 10 and a turnbar system 30 cooperating with the glue machine 10. The turnbar system is adapted to result in delivering a single-faced web 50 from the glue machine 10 to a double-facer 20 with the glue-applied exposed flute crests facing away from the hotplates 25 in the double-facer 20. The turnbar system of the present invention is particularly well suited to be used in conjunction with a glue machine as described in U.S. Pat. No. 6,602,546, incorporated hereinabove.

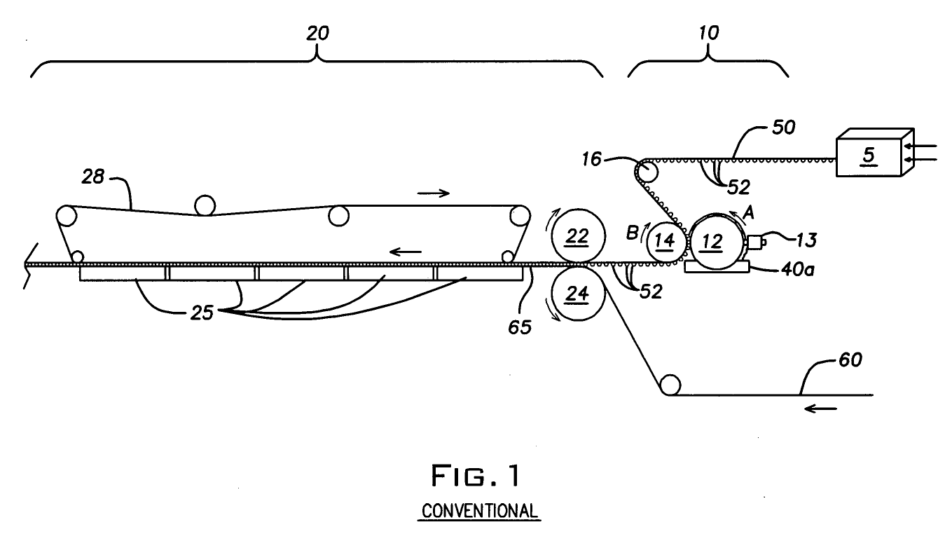

Such a glue machine 10 includes a glue applicator roll 12, a glue metering assembly 13 and a rider roll 14. In the conventional assembly of the glue machine 10 (seen in FIG. 1), a glue reservoir or trough 40a is located directly below the applicator roll 12 and extends below at least a portion of each of the metering assembly 13 and the rider roll 14. The applicator roll 12 is journaled for rotation about a horizontal and transverse rotational longitudinal axis 4 in the direction indicated by the arrow A (counterclockwise as viewed in FIG. 1). The applicator roll 12 is located above the glue trough 40a and is positioned so the lower portion of the applicator roll 12 is immersed in the adhesive within the trough 40a, during operation, at a coating position along the circumferential surface of the roll 12. As the applicator roll 12 rotates, a coating of adhesive is applied to the periphery of the applicator roll 12 at the coating position. The rider roll 14 is journaled for rotation about a horizontal and transverse rotational longitudinal axis 5 in the direction opposite that of the applicator roll 12 and indicated by arrow B (clockwise) as viewed in FIG. 1. The rider roll 14 is positioned on the forward or downstream side of the applicator roll 12 such that its rotational axis 5 is parallel to and located in substantially the same horizontal plane with the rotational axis 4 of the applicator roll 12. The metering assembly 13 is substantially coplanar with the axes 4 and 5. It is positioned adjacent the applicator roll 12 opposite the rider roll 14 such that it can properly meter the glue film thickness on the surface of the applicator roll 12 emerging from the trough 40a prior to reaching the gap 15 defined between the outer circumferential surfaces of the respective applicator and rider rolls 12 and 14. The gap 15 is oriented substantially vertically between the applicator roll 12 and the rider roll 14 (based on the horizontal coplanar alignment of their rotational axes 4 and 5) and defines a passage for a single-faced web 50 between the rolls for application of glue from the applicator roll surface to the exposed flute 52 crests. The position of the rider roll 14 is adjustable directly toward and away from the applicator roll 12 so that the width of the gap 15 can be precisely adjusted to control the degree to which the flutes 52 of the single-faced web 50 are compressed against the applicator roll 12 as they pass through gap 15.

In the figures, the glue machine 10 is shown having both a first stage gluing station (applicator roll 12, rider roll 14 and glue metering assembly 13 as described above), and a second stage gluing station located generally above the first stage, having a separate applicator roll 12a, rider roll 14a and metering assembly 13a. As will become apparent below, and as will be understood by a person of ordinary skill in the art, only the first stage gluing station is operated for producing double-faced corrugated board composite 65 as herein described; the second stage gluing station is used only when making triple-faced corrugated board (described below) commonly referred to as “double wall,” otherwise it remains dormant or it may be omitted altogether. Unless otherwise explicitly stated herein, the following description refers only to the first stage gluing station.

FIG. 1 shows, schematically, a conventional production line for making double-faced corrugated board composite incorporating the glue machine described above. From right to left, the conventional line includes:
a single facer 5 for making the single-faced web 50 from the corrugated sheet and the first-face sheet,
the glue machine (shown schematically at 10) for applying glue to the exposed flute crests of the single-faced web 50, and
a double-facer (shown schematically at 20) for adhering a second-face sheet web 60 to the glue-applied exposed flute crests in order to produce the finished double-faced cardboard composite 65 and for gelling starch in the glue.

Conventionally the single-faced web 50 is supplied to the glue machine 10 from the single-facer 5 with the flutes 52 facing downward, from the side of the glue machine 10 opposite the double-facer 20. The single-faced web 50 follows a web path through the glue machine 10 around the rider roll 14 and through the gap 15, such that the crests of the exposed flutes 52 come into contact with a glue film on the surface of the applicator roll 12 prior to exiting the glue machine 10, again flutes 52 facing downward, toward the double-facer 20. Conventionally, the second-face sheet web 60 also is fed from the side of the glue machine 10 opposite the double-facer 20, and is threaded through or around (typically through) the glue machine to be adhered or laminated to the glue-applied flute 52 crests between nip rollers 22 and 24 on entrance to the double-facer 20. The resulting composite is a double-faced corrugated web 65.

The double-facer 20 includes a set of stationary hotplates 25 defining a planar surface over which the newly made double-faced web 65 travels. A conveyor belt 28 is suspended over the hotplates and spaced a distance therefrom sufficient to accommodate the double-faced web 65 as it travels through the double-facer. The conveyor belt 28 frictionally engages the upwardly facing surface of the web 65, and conveys it through the double-facer 20 such that the downwardly facing surface is dragged against the stationary hotplates 25.

In the conventional production line for making double-faced corrugated cardboard composite 65 illustrated in FIG. 1, the single-faced web 50 enters the double-facer 20 with the glue-applied flute 52 crests facing downward toward the hotplates 25, and the second-face sheet web 60 is conveyed through the double-facer 20 against the stationary hotplates 25. This is far from ideal because it can result in scuffing the high-quality printed/printable surface for the printed indicia that are intended to appeal to consumers. In addition, when using a glue machine 10 that applies a high-solids (low-water) content glue to the exposed flute crests, which is highly desirable from an energy and material savings standpoint, the conventional single-facer 5 applies substantially more water to the first-face side of the composite (to glue the first-face sheet to the corrugated sheet) than the glue machine 10 applies to the second-face side (to glue the second-face sheet web 60 to the single-faced web 50). This means the double-faced composite web 65 is far wetter on the first-face side, conventionally facing upward away from the hotplates 25, than on the second-face side, conventionally facing downward toward the hotplates 25. As a result, the side with less water is heated more rapidly resulting in substantially uneven drying of the double-faced web 65 which can lead to significant warping of the finished composite. In addition, as explained above the second-face sheet web 60 typically is the face that is or will be printed on the outside of a package or container, and dragging this face across the high temperature hotplates can substantially diminish the print (printable) quality of this face.

The conventional production line for making double-faced corrugated board composite described above and illustrated in FIG. 1 is present in literally thousands of corrugator production facilities worldwide.

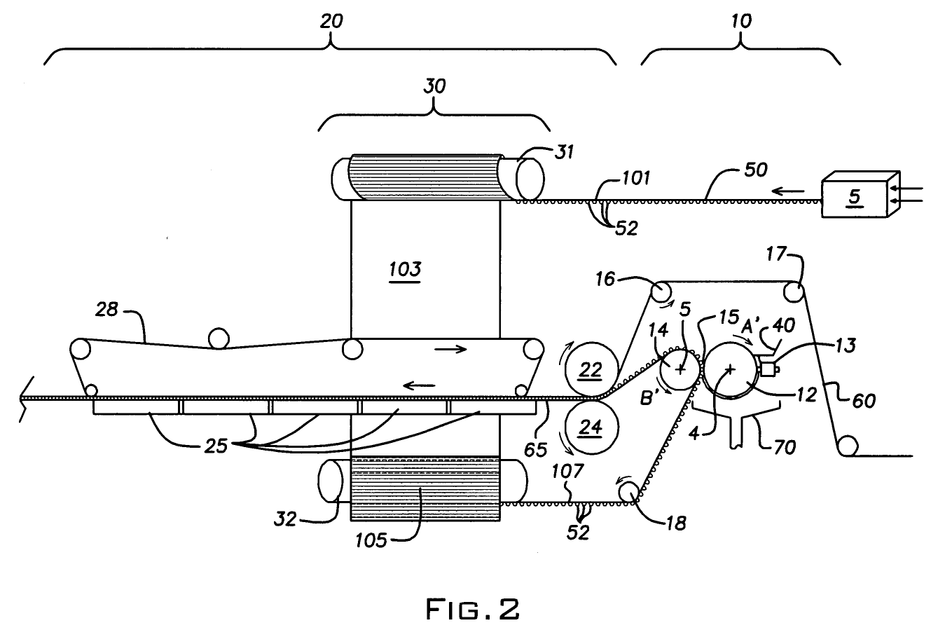

Referring now to FIG. 2, an improved corrugator line according to the invention is shown. In the embodiment shown in FIG. 2, a turnbar system 30 is provided or integrated with the glue machine 10. The illustrated turnbar system 30 includes a first, receiving turnbar 31 and a second, delivery turnbar 32. The receiving turnbar 31 is so-called because it receives the single-faced web 50 from the single-facer 5, and the delivery turnbar 32 is so-called because it delivers the web 50 to the glue machine, though from the opposite direction compared to the conventional line in FIG. 1. The receiving turnbar 31 is located generally forward (downstream) of the glue machine 10 relative to the source of the single-faced web 50 and is suspended above the double-facer 20 such that the web 50 proceeds along a path over or above the glue machine 10 to reach and be wound around the receiving turnbar 31. The delivery turnbar 32 likewise is located generally forward of the glue machine 10 relative to the source of the single-faced web 50, but is suspended below the double-facer 20 in order to deliver the web 50 to the glue machine 10 from the side adjacent the double-facer 20, opposite that of the conventional line shown in FIG. 1.

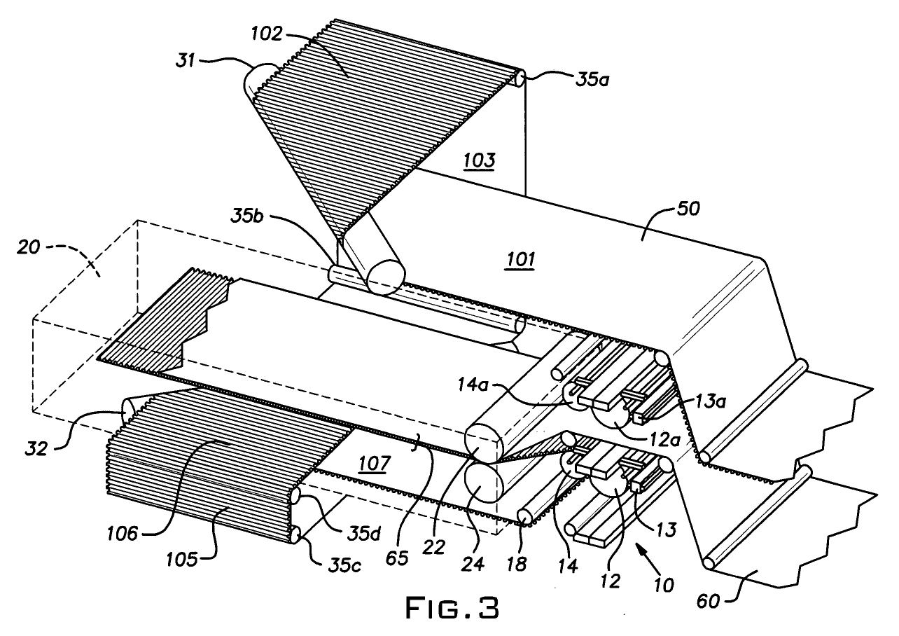

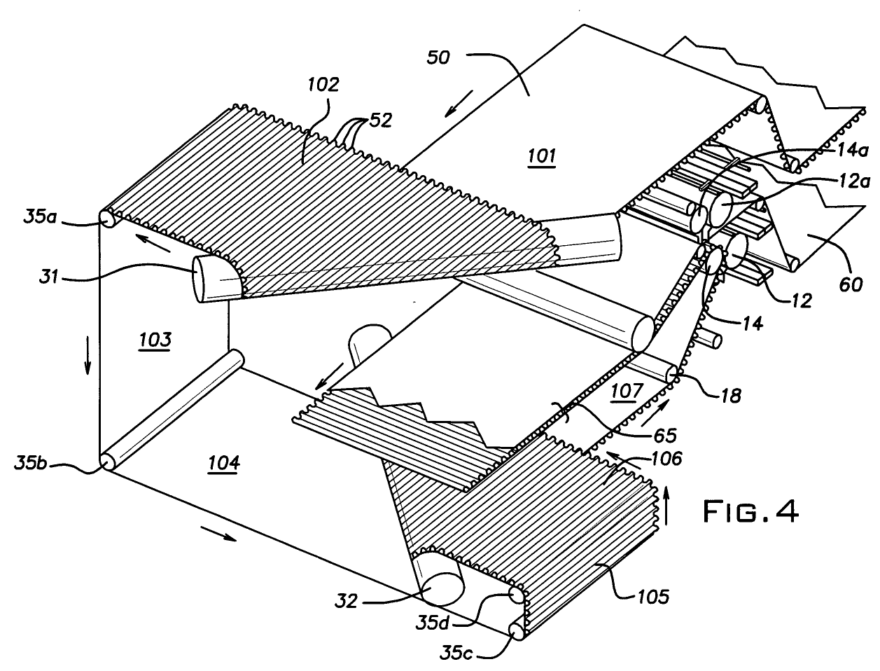

As best seen in FIGS. 3 and 4, each of the turnbars 31 and 32 has a longitudinal axis located in a horizontal plane. When viewed from above, each of the turnbars 31 and 32 is separately oriented at an angle of 45° relative to the web path direction of the entering single-faced web 50, and the receiving turnbar 31 is oriented perpendicular to the delivery turnbar 32. In addition, the turnbar system 30 also includes a series of longitudinal idler rollers 35 which, together with the turnbars 31 and 32, define the web path for the single-faced web 50 through the turnbar system 30 prior to entering the glue machine 10. In the illustrated embodiment, there are four longitudinal idler rollers, 35a, 35b, 35c and 35d which are positioned and oriented as follows.

The first longitudinal idler roller 35a is located generally at the same elevation as the receiving turnbar 31, and is spaced laterally from the turnbar 31 and laterally from the double-facer 20 when viewed from above, such that it runs generally parallel to the lengthwise direction of the double-facer 20. Also, the first idler roller 35a preferably is dimensioned and positioned such that a common horizontal plane tangentially intersects the uppermost portions of both the receiving turnbar 31 and the first idler roller 35a. The second idler roller 35b is parallel to the first idler roller 35a, preferably defining a substantially vertical plane therewith, which plane is spaced laterally a distance from the double-facer 20. Most preferably, the first and second idler rollers 35a and 35b have the same dimensions and have respective longitudinal axes that are coplanar in the same vertical plane. The third idler roller 35c is spaced a distance laterally from the double-facer 20, but on the opposite side of the double-facer 20 compared to the second idler roller 35b. The second and third idler rollers 35b and 35c are parallel and define a substantially horizontal plane which is located underneath the double-facer 20. Most preferably, the second and third idler rollers 35b and 35c have the same dimensions and have respective longitudinal axes that are coplanar in the same horizontal plane. The fourth idler roller 35d is located above and is parallel to, preferably defining a substantially vertical plane with, the third idler roller 35c, which plane is spaced laterally a distance from the double-facer 20 opposite the plane defined by the first and second idler rollers 35a and 35b. Most preferably, the third and fourth idler rollers 35c and 35d have the same dimensions and have respective longitudinal axes that are coplanar in the same vertical plane. The fourth idler roller 35d preferably is located at an elevation such that a horizontal plane tangent to the uppermost portion of the fourth idler roller 35d also is tangent to the uppermost portion of the delivery turnbar 32 which is located underneath the double-facer 20. The longitudinal idler rollers 35 and the turnbars 31 and 32 are maintained in their above-described positions (preferably such that each remains rotatable about its respective longitudinal axis) via known or conventional means which are not critical to the present invention, so long as the means employed do not obstruct or interfere with the web path through the turnbar system 30 for the single-faced web 50 as described in the following paragraph. For example, the turnbars 31 and 32 and the rollers 35 can be supported on a suitably constructed frame made from beams and/or other cross-members in a conventional manner which may or may not be fixed to the glue machine or a frame for the glue machine.

Still referring to FIGS. 3 and 4, with the turnbar system 30 having the construction described above the web path for the single-faced web 50 through the turnbar system proceeds as follows. The source for the single-faced web 50 (the single-facer 5) is located in the same position as in FIG. 1; that is, the position and orientation of the single-facer 5 are not disturbed by the present invention. Thus, the single-faced web 50 is fed from the same direction, and in the same orientation (flutes downward) as before, except now it is fed along a path over the glue machine 10 to the receiving turnbar 31, herein referred to as the first leg 101. The upper surface (first-face) of the single-faced web 50 tangentially contacts the bottom-most portion of the receiving turnbar 31 surface, and is wound around the turnbar 31 about 50% of its circumference (πradians) such that the web 50 is caused to proceed in a lateral direction toward the first longitudinal idler roller 35a along a second leg 102. As will be understood, due to the 45° angle of the receiving turnbar 31 relative to the web path direction of the entering single-faced web 50 (first leg 101), the second leg 102 proceeds at a 90° angle relative to the first leg 101 when viewed from above, in a lateral direction toward the first idler roller 35a. At the end of the second leg 102, the web 50 tangentially contacts the uppermost portion of the first idler roller 35a, and is wound around the first idler roller 35a about 25% of its circumference (π/2 radians) such that it is redirected in a downward direction toward the second idler roller 35b along a third leg 103. At the end of the third leg 103, the web 50 tangentially rounds the second idler roller 35b, again about 25% of its circumference (π/2 radians) as described above, and thereafter proceeds along a fourth leg 104 in a substantially horizontal plane underneath the double-facer 20 toward the third idler roller 35c. At the end of the fourth leg 104, the web 50 tangentially rounds the third idler roller 35c, again about 25% of its circumference (π/2 radians), proceeding along a fifth leg 105 in a substantially vertical plane toward the fourth idler roller 35d. At the end of the fifth leg 105, the web 50 tangentially rounds the fourth idler roller 35d, again about 25% of its circumference (π/2 radians), proceeding along a sixth leg 106 in a substantially horizontal plane toward the uppermost portion of the surface of the delivery turnbar 32. At the end of the sixth leg, the web 50 tangentially rounds the delivery turnbar 32 about 50% of its circumference (πradians), such that it ultimately is delivered back to the glue machine 10 along a seventh leg 107 from the direction opposite the single-facer 5 and adjacent the double-facer 20, oriented flutes facing downward. Because of the 45° angle of the delivery turnbar 32 relative to the direction of the sixth leg 106, and the direction of the entering web 50 (first leg 101) based on the geometry of the turnbar system as described, the web 50 is delivered to the glue machine 10 along a vector that is substantially parallel to that of the first leg 101, but which proceeds in the opposite direction; i.e. away from the double-facer 20.

It will be evident from the above description and from the web path through the turnbar system 30 as illustrated in FIGS. 3 and 4, that in all cases the surface of the web 50 contacting a turnbar (31,32) or an idler roller (35a-35d) is the first-face or flat surface, and not the fluted surface having flutes 52. (Note the web 50 is fed to the receiving turnbar 31 along the first leg 101 oriented flutes 52 facing downward). This is a desirable feature when using a glue machine capable of applying precisely metered amounts of glue as described in U.S. Pat. No. 6,602,546, preferred herein, because precision in crest-only glue application is achieved by regulating the degree of flute 52 compression against the applicator roll 12 in the glue machine. If the flutes 52 already are compressed (or if they are rebounding based on their modulus from a prior compression) on entering the glue machine, then this “pre-compression” must be compensated for in the glue machine 10 when applying glue to ensure precise crest-only glue application. However, by feeding the web 50 through the turnbar system 30 with the flutes 52 facing away from the turnbars 31,32 and the idler rollers 35, the flutes are not compressed at all through the turnbar system 30, regardless of web tension. As a result, the flutes 52 are not pre-compressed and are not rebounding from a prior compression on approach of the gap 15 between the applicator and rider rolls 12 and 14, meaning operation of the glue machine 10 to achieve precisely metered crest-only glue application is unaffected based on the turnbar system, regardless of tension in the web 50.

The above-described construction of the turnbar system 30 is but one preferred construction capable of achieving the desired effect, namely to accept the single-faced web 50 from the conventional direction and in the conventional orientation (from the single-facer 5, flutes facing downward) and to deliver the web 50 to the glue machine on the side opposite the single-facer 5 still oriented with the flutes facing downward. Based on this description, other turnbar system constructions will become apparent or evident to those skilled in the art without undue experimentation which will be effective to achieve the same result, though perhaps via a web path having somewhat different web path geometry than illustrated in FIGS. 3 and 4 based on the turnbars 31 and 32 and the idler rollers 35a-35d described herein.

The turnbar system according to the invention is effective to receive the single-faced web 50 from the same direction and in the same orientation (flutes facing downward) as in a conventional corrugator line, and to redirect the web 50 back toward the glue machine from the opposite direction, adjacent the double-facer 20, with the flutes 52 facing downward. More specifically, based on the illustrated embodiment the turnbar system 30 receives the single-faced web 50 from the single-facer 5 along a path above the glue machine 10, and conveys the web 50 laterally around and underneath the double-facer 20, back toward the glue machine from the opposite side, so the web 50 can be run through the glue machine in a reverse direction compared to the conventional installation shown in FIG. 1.

The web 50 exits the turnbar system 30 along the seventh leg 107, and is directed back toward the glue machine, around the rider roll 14 and through the gap 15 where glue is applied to the exposed crests of the flutes 52. A transverse idler roller 18 or a series of idler rollers can be used to help guide the web path through the glue machine 10. It will be evident from FIG. 2 that according to the invention, the single-faced web 50 travels through the gap 15 between the applicator and rider rolls 12 and 14 in the opposite direction (i.e. upward) compared to the conventional line shown in FIG. 1.

Specifically, because the single-faced web 50 is fed to the glue machine 10 from the downstream (double-facer 20) side with the flutes facing downward, the web 50 winds around the rider roll 14 and traverses the gap 15 in an upward direction so that the web 50 is delivered to the entrance of the double-facer 20 (nip rollers 22 and 24) from the uppermost portion of the surface of the rider roll 14, flutes facing upward. It will be evident by comparing FIG. 2 with FIG. 1 that this is the opposite of conventional corrugator line installations.

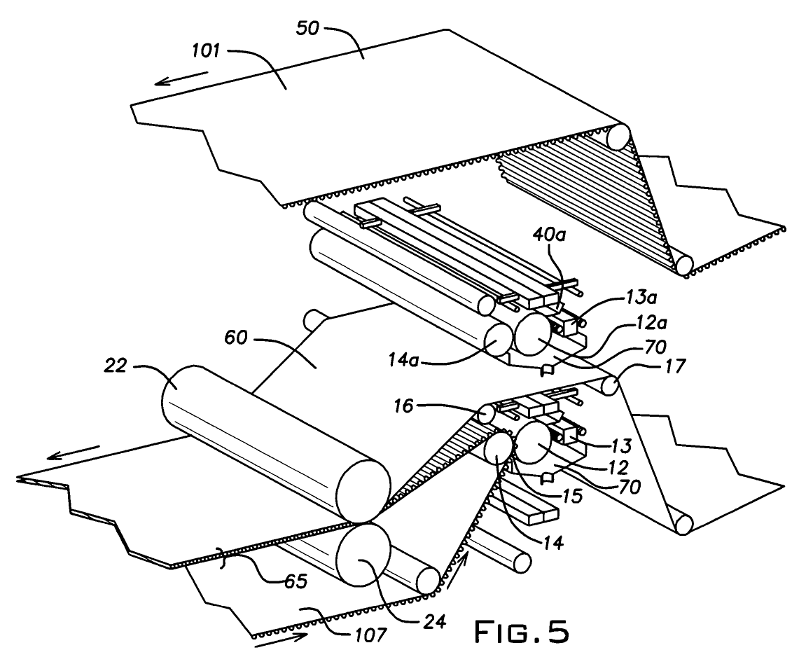

In order to accommodate the web 50 traveling upward through the gap 15 where glue is applied to the exposed crests of the flutes 52, the respective applicator and rider rolls 12 and 14 are operated in the reverse directions compared to the conventional line shown in FIG. 1. That is, as seen in FIG. 2, the applicator roll is rotated in a direction indicated by arrow A′ (clockwise in FIG. 2) and the rider roll is rotated in a direction indicated by arrow B′ (counterclockwise in FIG. 2). Glue is still applied to the exposed crests of the flutes 52 as they are compressed against the applicator roll 12 in the same manner as before, however certain modifications to the glue machine are necessary because of the opposite direction of operation. Specifically, it is important to properly meter the glue film thickness on the surface of the applicator roll 12 such that the film enters the gap 15 after being metered by the metering assembly 13 based on the direction of rotation of the applicator roll 12. Thus, in the glue machine according to the invention, it is not suitable to maintain the applicator roll immersed at its base in the glue trough 40a as shown in FIG. 1, because this would result in an unmetered glue film on the applicator roll 12 surface approaching the gap 15 based on the direction of rotation according to the invention. Preferably, the glue reservoir or trough is provided at the location indicated in FIG. 2 at 40b, generally above the metering assembly 13 adjacent the surface of the applicator roll 12. In this construction, based on the direction of rotation according to the invention (FIG. 2) the applicator roll 12 surface is coated with glue adjacent the reservoir 40b, and the resulting film is metered by the metering assembly 13 prior to entering the region of the gap 15. A drip pan 70 preferably is provided generally below but spaced apart from the base of the applicator roll 12 such that excess glue from the surface of the applicator roll can be collected in the drip pan 70. Preferably, the drip pan 70 has sufficient longitudinal extent such that it extends underneath both the glue metering assembly 13 and the gap 15 to collect excess glue removed from the surface of the roll 12 by the metering assembly 13 as well as any drippage from the glue application operation in the gap 15 between the rolls 12 and 14. See FIGS. 2 and 5.

Also as shown in FIGS. 2 and 5, the second-face sheet web 60 is fed from the same direction and location as in the conventional assembly; that is, from the upstream or single-facer side of the glue machine 10. According to the invention, the second-face sheet web 60 is fed generally up and over the applicator and rider rolls 12 and 14 of the glue machine 10, e.g. via lateral idler rollers 16 and 17, such that it passes over the applicator and rider rolls 12 and 14 in a direction toward the double-facer 20, but in a plane located below the first leg 101 of the web path for the single-faced web 50 through the turnbar system 30. This ensures the path of the second-face sheet web 60 web will not intersect or interfere with that of the single-faced web 50 through the turnbar system 30 and the glue machine 10. On the downstream side of the glue machine 10, the second-face sheet web 60 and the single-faced web 50 (now having glue applied to the exposed flute crests) converge at the nip point between the nip rollers 22 and 24 on entrance to the double-facer 20, where the flute crests are pressed against the second-face sheet web 60 to be adhered thereto, thereby forming the finished double-faced composite 65.

In its broadest aspect, the invention redefines the web path of the single-faced corrugated web 50 through a corrugator line, such that the geometry of the newly defined web path results in the single-faced web 50 entering the double-facer 20, after exiting the glue machine 10, oriented having the exposed flute crests facing in the opposite direction (upward or downward) from the direction the exposed flute crests were facing on approaching the glue machine 10 from the single-facer 5. In the preferred embodiment described above, the turnbar system 30 and the glue machine 10 cooperate with one another, and together define a web path for the single-faced web having a web path geometry as described in the preceding sentence; that is, such that the single-faced web 50 is delivered to the double-facer 20 (after exiting the glue machine) having its exposed flute crests facing the opposite direction from that which they faced on entering the web path defined by the glue machine 10 and the turnbar system 30. When the invention is applied to a conventional corrugator line, this results in the single-faced web 50 ultimately being delivered to the double-facer 20 (after exiting the glue machine 10) having the exposed flute crests facing upward even though the web 50 is delivered from the single-facer 5 to the web defined by the turnbar system 30 and the glue machine 10 having the exposed flute crests facing downward.

In the preferred embodiment described above, the redefined web path for the single-faced web 50 proceeds first through the turnbar system 30 and then subsequently through the glue machine prior to entering the double-facer 20; i.e. the turnbar system 30 is located upstream of the glue machine 10 along the web path for the single-faced web 50. However, it also is contemplated that a turnbar system can be designed based on the present disclosure without undue experimentation, and arranged with the glue machine 10 to define a web path such that the single-faced web 50 proceeds first through the glue machine 10 and then subsequently through the turnbar system prior to entering the double-facer 20; i.e. such that the turnbar system is located downstream of the glue machine along the web path for the single-faced web 50. In this embodiment, the glue machine is operated and the single-faced web 50 proceeds through the glue machine along the path shown in FIG. 1, but on exiting the glue machine the single-faced web 50 next proceeds through a turnbar system whose geometry is adapted to redirect the web path so the single-faced web 50 enters the double-facer 20 on exiting the turnbar system with the flutes facing the opposite direction compared to when exiting the glue machine. This arrangement is less preferred because the web 50 now must be conveyed through the turnbar system 30 after having glue applied to its exposed flute 52 crests in the glue machine 10, which may introduce undesirable or unpredictable variables into the corrugator operation. For example, by conveying the glue-applied flute crests through the turnbar system at high speed, some degree of evaporation will occur from the glue due to moisture convection, which is generally unpredictable. The degree of evaporation will be dependent on factors beyond the operator's control such as ambient temperature and the level of relative humidity. Thus it is preferred to deliver the web 50 from the glue machine 10 directly to the double-facer 20, and not first to a turnbar system and then to the double-facer 20.

As seen in FIGS. 2 and 5, when the system according to the invention is used the second-face sheet web 60 is located above the single-faced web 50 spaced apart from the hotplates 25 as it enters the double-facer 20, and is frictionally engaged by the conveyor belt 28 which is moving at the same speed as the composite 65. As a result, no scuffing of the second-face sheet side of the composite 65 occurs. At the same time, the flute crests to which glue was applied in the glue machine 10 also are facing upward, away from the hotplates 25, with the first-face sheet of the composite 65 (applied to the corrugated sheet in the single-facer 5), now facing downward toward the hotplates 25.

Thus, the corrugator line according to the invention results in the second-face sheet being conveyed against the conveyor belt 28 and not against the hotplates 25, and also in the first-face sheet of the composite 65 facing downward toward the hotplates 25. This has several highly beneficial advantages. First, it is now possible to operate a corrugator line using a glue machine that can apply high-solids, low-moisture content glue to the crests of the exposed flutes 52 in the single-faced web 50 without contributing to potentially irreversible warping of the finished double-faced corrugated composite 65. This is because the side of the composite 65 having the highest moisture content faces the hotplates, and therefore is dried at a faster rate than the opposite side where the moisture content is lower. By drying the wetter side of the composite 65 more rapidly, the time to dry both sides of the composite (first- and second-face sides) is made more equal and warping of the composite 65 due to one side being wet and one side substantially dry is reduced or eliminated. Thus, by the present invention it is no longer necessary to wastefully supply more glue at the glue machine 10 than is necessary to achieve a bond between the flute crests and the second-face sheet web 60 just to balance out the moisture on both sides of the composite 65. Instead, the glue machine 10 now can apply a high-solids, low-moisture content glue to the flutes 52 despite the resulting moisture imbalance in the double-faced composite 65 when using a conventional single-facer 5, without irreversibly warping the composite 65 as otherwise may result. Consequently, a point of substantial waste (both material and cost) is eliminated with little or no adverse effect in the double-faced composite 65, and without the expense of retrofitting the single-facer to supply less moisture.

A second substantial advantage is that according to the invention the second-face sheet web 60 is spaced apart and insulated from the hotplates 25 by the single-faced web 50. This provides a much longer time for the starch in the glue to penetrate the second-face sheet web 60 from the crests of the flutes 52 before reaching the gel point. Typically, the starch in the glue lines adhering the first-face sheet to the corrugated sheet is already gelled by the time the single-faced web 50 approaches the entrance to the double-facer 20, so there is no danger it will gel prior to penetrating sufficiently into the first-face sheet to achieve an effective bond. Conversely, the glue between the second-face sheet web 60 and the corrugated sheet, just applied at the glue machine 10, does not gel until after it reaches the double-facer. When the second-face sheet web 60 is oriented in the conventional manner, downward against the hotplates 25, a significant quality control problem arises in that the starch between the second-face sheet web 60 and the corrugated sheet can gel prior to penetrating sufficiently into the second-face sheet to achieve an effective bond. By orienting the second-face sheet web 60 (and the proximate flute crests) remote from the hotplates 25, insulated therefrom by the first-face sheet and the corrugated sheet, the starch is allowed more time to penetrate the second-face sheet web 60 prior to reaching the gel point. In this manner, the control window for gelling the starch in the second-face sheet web 60 is widened without adding water, which would tend to make the overall composite 65 more dimensionally unstable.

Third, the second-face sheet web 60 forms the outer surface of the double-faced corrugated composite 65, on which indicia are printed to appeal to consumers of products. Washboarding is a known phenomenon resulting from glue being applied too broadly to the flutes 52 such that it covers not only the crests but also the leading and/or trailing slopes of the flutes. When this happens, the second-face sheet web 60 is caused to adhere not only to the crests but also it “wicks” or is drawn inward to adhere to the glue present in the valleys between adjacent flute crests, resulting in the well known “washboarding” effect. This washboarding effect compromises the appearance of the finished composite so that it is unattractive to the consumer. Also, if the second-face sheet web 60 is not preprinted prior to feeding it to the double-facer 20, the washboarded surface substantially impedes effective printing of quality images thereon. Because the gel point of the starch in the glue applied at the glue machine is delayed compared to the conventional corrugator line (see preceding paragraph), less starch (and therefore less glue) need be applied at the glue machine because the starch has longer to penetrate before gelling so less starch is necessary. One highly beneficial result of applying less glue to the flutes 52 in the glue machine 10 is the substantially reduced tendency for washboarding of the second-face sheet web 60 in the finished corrugated composite 65. This is because the less glue that is applied, the more precisely a glue line can be controlled so that it is applied only to the crests of the flutes 52 such that none or substantially none is provided on the leading or trailing slopes of the flutes as they traverse the gap 15 against the applicator roll 12 in the glue machine.

Fourth, because the second-face sheet web 60 no longer is conveyed against a stationary hot surface (hotplates 25), high quality preprinted or coated grades can be used as the second-face sheet web 60 which can be fed directly to the double-facer 20 in the corrugator line illustrated in FIG. 2, such that no scuffing of the second-face sheet web 60 will occur. As will be understood, whether preprinted or post-printed, finished boxes or other containers made using the double-faced corrugated composite 65 have substantially higher quality graphics, or the potential for higher quality graphics, when made according to the invention compared to conventional corrugated composites made by dragging the second-face sheet web 60 against the hotplates (FIG. 1).

A further substantial advantage of the present invention is that by positioning the second-face sheet web 60 in a position such that it is spaced apart and insulated from the hotplates 25, it is now possible to use materials for the second-face sheet web 60 that heretofore have not been possible due to their heat sensitivity. For example, conventional coated grades for the second-face sheet web 60 include polyester-coated board which is relatively expensive. Using the present invention, because the face sheet 60 is now maintained remote and insulated from the hotplates, it is possible to use, e.g., polyethylene-coated board. Polyethylene on average is about $200 per ton less expensive than polyester, making it a much more highly desirable coating material from a cost savings standpoint. However, until the present invention it has not been possible to use polyethylene to coat the face sheet 60 due to its heat sensitivity; polyethylene would reach its softening point and melt on being dragged across the hotplates if oriented face downward, meaning until now its use was not an option.

In addition, on preprinted grades, conventionally care had to be taken to ensure the inks used would not run or smear on dragging against the high temperature hotplates. In general, any material having a melting or softening point below the temperature of the hotplates conventionally could not be used because it would result in a diminished quality printed surface when the second-face sheet web was conveyed through the double-facer against the hotplates 25. Conversely, by employing the invention temperature and smear sensitivity of the inks used on preprinted grades is of substantially less concern because the printed surface no longer is dragged across the high temperature hotplates. Accordingly, it is possible by the present invention to use preprinted grades of the second-face sheet web 60, e.g. having an image made using an ink having relatively high temperature sensitivity, wherein the preprinted image is substantially unaltered on exit of the double-faced corrugated composite from the double-facer. According to the present invention, a wide variety of coating materials and inks which previously could not be used due to their temperature sensitivity now are available for corrugated board manufacturers and their customers in order to provide a finished corrugated product that is as attractive to consumers as possible. In one embodiment according to the invention, one can replace the second-face sheet web 60 altogether with a sheet or web of plastic material; i.e. no paper. This is a substantial advantage of the invention over the prior art.

The turnbar system 30 of the present invention can be installed to operate in conjunction with substantially any conventional glue machine in order to feed the single-faced web 50 from the opposite direction, and thereby to feed it to the double-facer 20 oriented flutes facing upward or away from the hotplates 25. It is noted that certain modifications may be necessary to the glue machine in order to enable operating in the reverse direction, for example introduction of the glue reservoir 40b and the drip pan 70 discussed above and illustrated in FIG. 2. Such modifications are within the skill of a person of ordinary skill in the art without undue experimentation, and will depend on the particular glue machine present in the corrugator line installation. However, in order that the glue machine 10 can be operated in the reverse direction without being realigned (e.g. rotated 180° when viewed from above), it is necessary the applicator roll 12 and the rider roll 14 can be operated in the reverse direction, as well as in the forward direction. The glue machine disclosed in U.S. Pat. No. 6,602,546 is capable of such reverse operation.

As discussed above, the present invention finds great applicability where it is desired to operate the glue machine 10 to deliver high-solids, low moisture content glue to the flute crests of the single-faced web 50. However, where the turnbar system 30 has been installed but it is desired nonetheless to use conventional glue materials having low-solids content, and particularly where surface scuffing is of little concern, it may be desirable to run the corrugator line in the conventional manner with the second-face sheet web 60 oriented downward toward the hotplates 25. In that event, the single-faced web 50 simply is threaded through the glue machine 10 in the conventional manner (FIG. 1) bypassing the turnbar system 30, and the glue machine is operated in the forward direction. When it becomes desirable again to use high-solids glue or when surface scuffing of the second-face sheet web 60 becomes of concern, operating according to the invention simply is a matter of rethreading the single-faced web 50 through the turnbar system 30 according to the invention. In other words, the turnbar system 30 can be installed and either operated or bypassed without difficulty, and without adversely affecting the remainder of the corrugator line. Thus, another substantial advantage of the present invention is that the glue machine 10 and associated turnbar system 30 according to the invention can be installed in an otherwise conventional corrugator production line without the need to retrofit or modify other equipment or its placement in the line, yet still result in delivering the single-faced web 50 to the double-facer 20 with the glue-applied flute crests facing upward away from the hotplates 25 when it is desired to operate in this mode according to the invention. Yet, even with the system according to the invention installed, it is not necessary to operate in this mode, and the glue machine can be operated in the conventional forward direction if desired with minimal modification required to switch between the conventional, and the invented modes of operation.

In the description above, and as shown in FIGS. 2 through 5, only the first stage gluing station is employed because only one stage is necessary to apply glue to the flute crests of one single-faced web 50 for making a double-faced composite 65. To produce the double-faced corrugated composite 65, one need only use the first stage gluing station (rolls 12 and 14, and metering assembly 13), leaving the second stage (rolls 12a and 14a, and metering assembly 13a) unused.

However, the turnbar system 30 also can be used in conjunction with a glue machine having two gluing stages to make a triple-faced corrugated composite (often referred to as “double wall”) according to the principles of the invention, having the overall structure:
first-face sheet: corrugated sheet: second-face sheet: corrugated sheet: third-face sheet

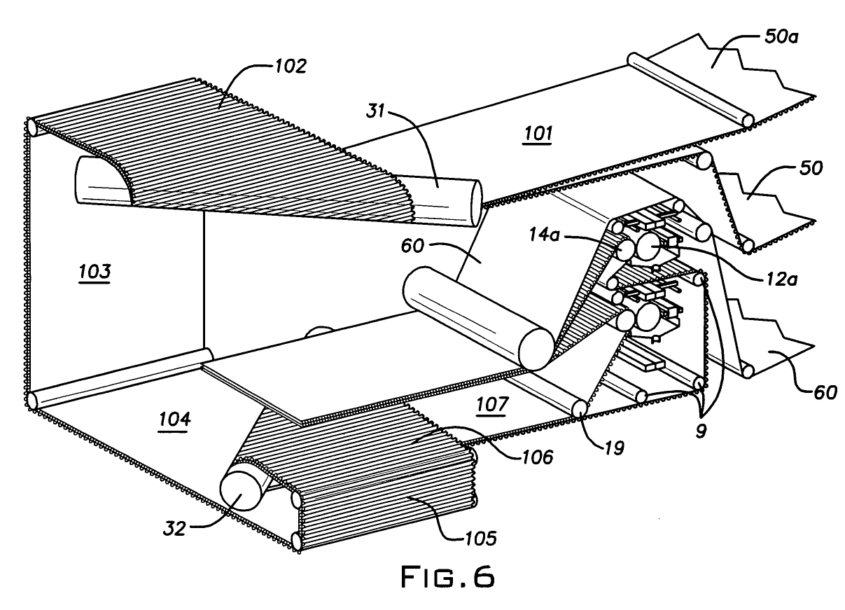

Referring to FIG. 6, two single-faced webs, 50 and 50a, are provided substantially in register via conventional means along the first leg 101 toward the receiving turnbar 31. Preferably, each of the single-faced webs 50 and 50a is made by a separate single-facer, and then the two webs are brought in register such that they are fed together along substantially the same path over the glue machine and toward the receiving turnbar 31 as shown in FIG. 6. In the figure, both the single-faced webs 50 and 50a are supplied to the receiving turnbar 31 along the first leg 101, oriented flutes downward as is conventional. The turnbar system 30 cooperates with the glue machine 10 to accept the two co-registered webs 50 and 50a from the side of the glue machine opposite the double-facer 20, both oriented flutes downward, and to direct their paths through the glue machine such that on exit of the glue machine both webs 50 and 50a are delivered to the double-facer 20 oriented flutes facing upward. The operation of the turnbar system 30 and the glue machine 10 to achieve this result for both the webs 50 and 50a will now be described.

The co-registered first and second single-faced webs 50 and 50a proceed from the first leg 101 through the turnbar system 30, e.g. via second, third, fourth, fifth, sixth and seventh legs 102 through 107 as above described, until reaching the lateral idler roller 19 located adjacent the base of the glue machine on the downstream side thereof (facing the double-facer 20). On reaching the roller 19, the two webs are separated with the second single-faced web 50a (the upper one of the two co-registered webs) being threaded to the first stage gluing station, and the first single-faced web 50 (lower of the two co-registered webs) being threaded to the second stage gluing station. Specifically, on reaching the idler roller 19, the second single-faced web 50a is threaded directly from the roller 19 to and tangentially around the first stage rider roll 14, through the gap 15 where glue is applied to the exposed flute crests. After rounding the rider roll 14, the second single-faced web 50a is conveyed toward the entrance to the double facer (nip rollers 22 and 24) oriented flutes facing upward as described above. At the same time, the first single-faced web 50 is threaded, via a series of lateral idler rollers 9, to and tangentially around the second stage rider roll 14a, through the gap 1 Sa where glue is applied to the exposed flute crests. Analogous to the second single-faced web 50a, after rounding the second stage rider roll 14a, the first single-faced web 50 is conveyed toward the entrance to the double facer (nip rollers 22 and 24) oriented flutes facing upward. Methods of threading these webs through the glue machine 10 are well known in the art, and will not be further described here. The key to the application of the invention as described in this paragraph is that, as seen in FIG. 6 and herein described, both the first and the second single-faced webs 50 and 50a exit the glue machine and enter the double-facer 20 oriented flutes facing upward, away from the hotplates 25. In the illustrated embodiment, this is achieved by redirecting the paths of these webs such that they enter the glue machine from the downstream side (adjacent the double-facer 20) oriented flutes facing downward, such that on rounding their respective rider rolls 14 and 14a, each emerges from the glue machine oriented flutes facing upward.

The second-face sheet web 60 is supplied in the conventional manner as before, except now it must be fed up and over both the first and the second stage applicator and rider rolls 12,12a and 14,14a in a plane located below the first leg 101 of the web path for the single-faced webs 50 and 50a. This ensures the path of the second-face sheet web 60 will not intersect or interfere with the web path of either the single-faced webs 50 and 50a through the turnbar system 30 and the glue machine 10. On the downstream side of the glue machine 10, the second-face sheet web 60 and the single-faced webs 50 and 50a (now having glue applied to the exposed flute crests of each) converge at the nip point between the nip rollers 22 and 24 on entrance to the double-facer 20 as above. In this embodiment, the second single-faced web 50a, having gone through the lower-most (first) gluing stage in the glue machine, is located at the bottom, the first single-faced web 50 is located in the middle, and the second-face sheet web 60 (here it might be termed the third-face sheet because it is the third of three flat sheets forming the composite) is located at the top, yielding the overall composite construction:
first-face sheet: corrugated sheet: second-face sheet: corrugated sheet: third-face sheet

At the nip point on entrance to the double-facer 20, the flute crests of the second web 50a are pressed against the face sheet of the first web 50, and the flute crests of the first web 50 are pressed against the face sheet 60, thereby forming a finished triple-faced or “double wall” corrugated composite having the above construction.

Although the invention has been described with respect to preferred embodiments, the invention is not to be correspondingly limited thereto, and it will be understood that various modifications can be made thereto without departing from the spirit and the scope of the invention as set forth in the appended claims.

1. Apparatus for producing a corrugated product, said apparatus comprising a glue machine, a double-facer and a turnbar system, said glue machine being adapted to apply glue to exposed flute crests of a single-faced corrugated web traveling through said glue machine, said turnbar system cooperating with said glue machine to define a web path for said traveling single-faced web, said web path having a web path geometry such that said single-faced web following said web path will enter said double-facer, after exiting said glue machine, having its exposed flute crests facing a direction opposite from the direction faced by the exposed flute crests on entry of said single-faced web in said web path.

2. Apparatus according to claim 1, said web path being effective to receive said traveling single-faced web having the exposed flute crests facing downward, and to deliver said single-faced web to said double-facer, after exiting said glue machine, having the exposed flute crests facing upward.

3. Apparatus according to claim 1, said turnbar system being located upstream of said glue machine along said web path.

4. Apparatus according to claim 1, said turnbar system comprising a receiving turnbar located above said double-facer and adapted to receive said single-faced web along a first leg of said web path, and a delivery turnbar located below the double-facer and adapted to deliver said single-faced web to said glue machine, wherein, when viewed from above each of said turnbars is separately oriented at an angle of 45° relative to the direction of said first leg of said web path and said receiving turnbar is oriented perpendicular to said delivery turnbar.

5. Apparatus according to claim 4, said turnbar system further comprising a series of longitudinal idler rollers which, together with said receiving and delivery turnbars, define the web path for said single-faced web through the turnbar system.

6. Apparatus according to claim 1, said receiving turnbar being located forward of said glue machine relative to a source of said single-faced web such that said first leg of said web path proceeds above the glue machine, said delivery turnbar also being located forward of said glue machine relative to the source of said single-faced web to deliver said single-faced web to said glue machine from the side opposite the source of said single-faced web.

7. Apparatus according to claim 1, said glue machine comprising a first stage gluing station comprising a first glue applicator roll and a first rider roll, each said roll being journaled for rotation about its own respective longitudinal axis, the longitudinal axes of said first applicator and rider rolls being parallel and together defining a substantially horizontal plane, wherein a first substantially vertically oriented gap is defined between outer circumferential surfaces of the respective first applicator and rider rolls, said first gap accommodating said web path for application of glue from the applicator roll surface to exposed flute crests of said single-faced web traveling through said first gap along said web path.

8. Apparatus according to claim 7, said applicator and rider rolls each being operable in both forward and reverse directions.

9. Apparatus according to claim 7, said first stage gluing station further comprising a glue metering assembly positioned adjacent said first applicator roll and being effective to meter the thickness of a glue film applied on the outer circumferential surface of said first applicator roll.

10. Apparatus according to claim 7, said glue machine further comprising a second stage gluing station located generally above the first stage gluing station, said second stage gluing station comprising a second glue applicator roll and a second rider roll, wherein a second substantially vertically oriented gap is defined between outer circumferential surfaces of the respective second applicator and rider rolls.

11. Apparatus for producing a corrugated product, comprising:
a glue machine for applying glue to exposed flute crests of a single-faced corrugated web traveling therethrough, and
a double-facer adapted to receive said single-faced web after said single-faced web exits said glue machine, and to direct a second-face sheet into contact with said exposed flute crests, thereby to bond said single-faced web to said second-face sheet to form a double-faced corrugated composite web,
said apparatus defining a web path therethrough for said traveling single-faced web, said glue machine being located upstream of said double-facer along said web path, said web path having a web path geometry such that said single-faced web following said web path will enter said double-facer having its exposed flute crests facing a direction opposite from the direction faced by the exposed flute crests on entering said glue machine along said web path.

12. Apparatus according to claim 11, said apparatus further comprising a single-facer for producing said single-faced corrugated web, said single-facer being located upstream of said glue machine along said web path, said web path geometry being such that said single-faced web following said web path will enter said double-facer having its exposed flute crests facing a direction opposite from the direction faced by the exposed flute crests on exiting the single-facer.

13. Apparatus according to claim 11, said apparatus further comprising a turnbar system comprising a plurality of turnbars that cooperate with said glue machine to define said web path having said web path geometry.

14. Apparatus according to claim 12, said apparatus further comprising a turnbar system comprising a plurality of turnbars that cooperate with said glue machine to define said web path having said web path geometry.

15. A method of producing a corrugated product, comprising the steps of:
delivering a single-faced corrugated web, having glue applied to exposed flute crests thereof, to a double facer comprising at least one stationary hotplate defining a planar surface, and
conveying said single-faced web through said double-facer along a substantially planar path that is parallel to and located adjacent said planar surface defined by said at least one hotplate,
wherein on entering the double-facer said single-faced web is oriented such that its exposed flute crests are facing away from said planar surface defined by said at least one stationary hotplate.

16. A method according to claim 15, said double-facer comprising a plurality of stationary hotplates defining said planar surface.

17. A method according to claim 15, further comprising delivering said single-faced web to the entrance of said double facer oriented such that the exposed flute crests are facing upward.

18. A method according to claim 15, said single-faced web being conveyed through said double-facer oriented such that the exposed flute crests are facing upward.

19. A method according to claim 15, further comprising delivering a second-face sheet web to the entrance of said double-facer along a path substantially in register with said single-faced web, said second-face sheet web being located on the side of the single-faced web facing the exposed flute crests thereof.

20. A method according to claim 19, further comprising contacting said second-face sheet web with the exposed flute crests of said single-faced web and forming a bond therebetween to produce a double-faced corrugated composite, wherein said second-face sheet web is conveyed through said double-facer spaced apart from said at least one hotplate.

21. A method according to claim 20, said second-face sheet web being insulated from said at least one hotplate in the double-facer by said single-faced web.

22. A method according to claim 20, said second-face sheet web being frictionally engaged against, and conveyed through said double-facer by, a conveyor belt traveling at the same speed as the second-face sheet web.

23. A method according to claim 22, wherein substantially no scuffing of the second-face sheet web results from being conveyed through the double-facer.

24. A method according to claim 20, said second-face sheet web being polyethylene-coated board.

25. A method according to claim 20, said second-face sheet web being preprinted with inks or coated with a material whose temperature sensitivity would result in a diminished quality printed surface if the second-face sheet web were conveyed through the double-facer against said at least one hotplate.

26. A method according to claim 20, said second-face sheet web being provided with a preprinted image using an ink having relatively high temperature sensitivity, wherein said preprinted image is substantially unaltered on exit of said double-faced corrugated composite from said double-facer.

27. A method according to claim 20, said second-face sheet being a web of plastic material.

28. A method according to claim 27, said plastic material having a softening point below an operating surface temperature of said at least one hotplate.

29. Apparatus for producing a corrugated product, comprising a glue machine for applying glue to exposed flute crests of a single-faced corrugated web traveling therethrough,
a double-facer adapted to receive said single-faced web after said single-faced web exits said glue machine, and effective to cause a second-face sheet to come into contact with said exposed flute crests, thereby to bond said single-faced web to said second-face sheet to form a double-faced corrugated composite web,
and means for directing a web path for said single-faced corrugated web through said apparatus to provide a web path geometry such that said single-faced corrugated web, following said web path, will enter said double-facer having its exposed flute crests facing a direction opposite from the direction faced by the exposed flute crests on entering the apparatus.

30. An apparatus according to claim 29, said means for directing a web path comprising a turnbar system.
